(19) United States
(12) Patent Application Publication
(10) Pub. No.: US 2021/0369425 A1
(43) Pub. Date: Dec. 2, 2021

(54) ORAL CLEANSING DEVICE WITH REMOVABLE TIP HOLDER

(71) Applicant: WATER PIK, INC., Fort Collins, CO (US)

(72) Inventor: Jeremy James Johnson, Fort Collins, CO (US)

(21) Appl. No.: 16/884,299

(22) Filed: May 27, 2020

(51) Int. Cl. A61C 17/02; A46B 15/00; A46B 11/06; A46B 9/04; A46B 17/08

(52) U.S. Cl. CPC A61C 17/0202; A46B 15/0095; A46B 11/063; A46B 7/044; A46B 17/08; A46B 2200/1066; A46B 9/04

(57) ABSTRACT

An oral cleansing device including a base and a tip holder configured to hold a tip for the oral cleansing device, such as a brush head, a jet tip, or a combination tip. The tip holder may be removably coupled to the base.

### TECHNICAL FIELD

One or more embodiments of the present disclosure relate generally to oral cleansing devices and more particularly, for example, to a removable tip holder.

### BACKGROUND

Some oral cleansing devices, such as oral irrigators, toothbrushes, and combination units (units that provide both a toothbrush function and an irrigating function), include two or more tips, such as brush heads and jet tips. For example, often a single unit may be used by two or more users and for hygienic and other reasons, and each user may wish to use his or her own tip. As another example, some units may include specialty tips, e.g., tips that enhance cleaning around braces, dental work, or implants, or are made for cleaning specific areas of the mouth, such as the tongue or periodontal pockets, and users may switch between tips depending on the desired cleaning function or as tips need to be replaced. As such, many oral cleansing devices may be sold with two or more tips and include storage for such tips (e.g., within a compartment on the device or separate container). However, the tip storage may detract from the aesthetic and/or functional appeal of the device, such as increasing the overall size of the device to accommodate for the storage area.

Therefore, there is a need in the art for an oral cleansing device that addresses the deficiencies noted above, other deficiencies known in the industry, or at least offers an alternative to current techniques.

### SUMMARY

According to one or more embodiments of the present disclosure, an oral cleansing device is disclosed. The oral cleansing device may include a base and an tip holder configured to hold a tip for the oral cleansing device, where the tip holder is removably coupled to a top surface of the base.

According to one or more embodiments of the present disclosure, a tip holder for user with an oral cleansing device is disclosed. The tip holder may include a support stand, a tip retainer extending from the support stand, and a magnetic element coupled to the support stand and configured to removably secure the tip holder to the oral cleansing device.

According to one or more embodiments of the present disclosure, an oral cleansing device is disclosed. The oral cleansing device may include a reservoir, a handle having a removably tip and in fluid communication with the reservoir, a base supporting the reservoir, and a tip holder removably coupled to the base and configured to support the removable tip in an upright position relative to the base.

Additional features are set forth in part in the description that follows and will become apparent to those skilled in the art upon examination of the specification and drawings or may be learned by the practice of the disclosed subject matter. A further understanding of the nature and advantages of the present disclosure may be realized by reference to the remaining portions of the specification and the drawings, which forms a part of this disclosure.

One of skill in the art will understand that each of the various aspects and features of the disclosure may advantageously be used separately in some instances, or in combination with other aspects and features of the disclosure in other instances. Accordingly, individual aspects can be claimed separately or in combination with other aspects and features. Thus, the present disclosure is merely exemplary in nature and is in no way intended to limit the claimed invention or its applications or uses. It is to be understood that structural and/or logical changes may be made without departing from the spirit and scope of the present disclosure.

The present disclosure is set forth in various levels of detail and no limitation as to the scope of the claimed subject matter is intended by either the inclusion or non-inclusion of elements, components, or the like in this summary. In certain instances, details that are not necessary for an understanding of the disclosure or that render other details difficult to perceive may have been omitted. Moreover, for the purposes of clarity, detailed descriptions of certain features will not be discussed when they would be apparent to those with skill in the art so as not to obscure the description of the present disclosure. The claimed subject matter is not necessarily limited to the arrangements illustrated herein, with the scope of the present disclosure is defined only by the appended claims.

### BRIEF DESCRIPTION OF THE DRAWINGS

The description will be more fully understood with reference to the following figures in which components may not be drawn to scale, which are presented as various embodiments of the oral cleansing device and tip holder described herein and should not be construed as a complete depiction of the scope of the oral cleansing device.

FIG. 1 is a top front isometric view of an oral cleansing device including a removable tip holder.

FIG. 2 is a front elevation view of the oral cleansing device of FIG. 1 with a handle for the oral cleansing device removed.

FIG. 3A is a cross-section view of the oral cleansing device of FIG. 2 taken along line 3A-3A in FIG. 2.

FIG. 3B is a cross-section view of the oral cleansing device of FIG. 1 taken along line 3B-3B in FIG. 1.

FIG. 4 is a partially exploded isometric view of the oral cleansing device of FIG. 1 taken along a cross-section similar to FIG. 3A.

FIG. 5 is an enlarged cross-section of the oral cleansing device of FIG. 3A.

FIG. 6 is a top front isometric view of the oral cleansing device similar to FIG. 1 with the handle and the tip holder removed.

FIG. 7 is a partially exploded view of a base portion of the oral cleansing device, including the tip holder of FIG. 1 and a tip.

FIG. 8A is a bottom isometric view of the tip holder of FIG. 7.

FIG. 8B is a top isometric view of the tip holder of FIG. 7.

FIG. 8C is a bottom plan view of the tip holder of FIG. 7.

FIG. 8D is a cross-section of the tip holder of FIG. 7 taken along line 8D-8D in FIG. 8B.

Embodiments of the disclosure and their advantages are best understood by referring to the detailed description that follows. It should be appreciated that like reference numerals are used to identify like elements illustrated in one or more of the figures.

### DETAILED DESCRIPTION

According to the present disclosure, an oral cleansing device with a removable tip holder is disclosed. The tip holder may include a magnetic element (e.g., a magnet or ferromagnetic material) configured to interact with a corresponding magnetic element (e.g., a magnet or ferromagnetic material) in the oral cleansing device. The interaction of the magnetic elements couples the tip holder to the oral cleansing device, but allows a user to remove the tip holder from the oral cleansing device when the tip holder is not in use or desired by the user. The tip holder may support many different types of tips (e.g., brush heads, jet tips, etc.) thereon.

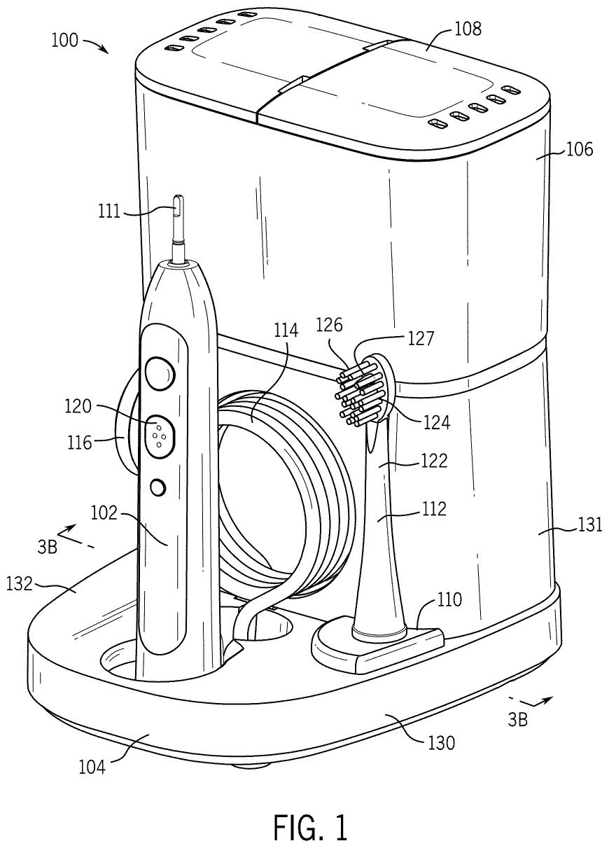

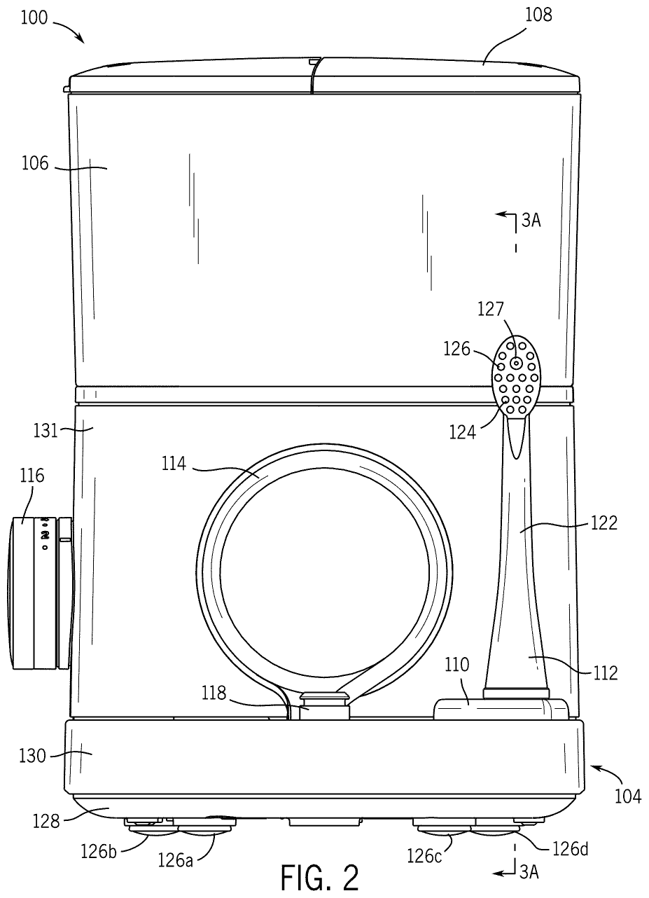

FIG. 1 is an isometric view of an oral cleansing device 100 in accordance with an embodiment of the disclosure. FIG. 2 is a front elevation view of the oral cleansing device 100 with handle 102 removed. As shown, the oral cleansing device 100 may be in the form of a countertop device and include a handle 102 and a tip 112 positioned on a base 104. In the embodiment illustrated in FIG. 1, the oral cleansing device 100 is an irrigating toothbrush having both a brushing function and an irrigating function. In other embodiments, however, the oral cleansing device 100 may be an electric toothbrush, an oral irrigator, or other device with a cleaning attachment. In such embodiments, a “tip” may refer to any cleaning attachment securable to the handle 102 without intent to limit.

The oral cleansing device 100 may include a base 104 that supports the handle 102 and optionally houses select components of the oral cleansing device 100, such as a pump, motor, and the like. In this manner, the base 104 may form a housing for the oral cleansing device 100 and may be configured to be positioned on a support surface, e.g., countertop, table, etc. With reference to FIG. 2, the base 104 may include a platform or shelf 130 and a reservoir support portion 131. The platform or shelf 130 may provide stability to the base 104, and a reservoir 106 may be positioned on the top of the reservoir support portion 131. The reservoir support portion 131 may extend upwards from the platform 130, such that the base 104 may have a “L” shaped profile. The platform 130 may include a top surface 132. The top surface 132 may be relatively planar, and in some examples may include one or more cutouts or recesses for select components, such as, but not limited to, fluid connectors, hoses, or the like. The platform 130 and the reservoir support portion 131 may be formed integrally as a single component or individually as separate components and coupled together.

One or more feet 126a, 126b, 126c, 126d may be coupled to a bottom surface of the base 104, such as coupled to a button surface of the lower portion 128. The feet 126a, 126b, 126c, 126d may act to reduce vibrations from being transmitted from the oral cleansing device 100 to the support surface and/or raise the height of the oral cleansing device 100.

In instances where the oral cleansing device 100 is an oral irrigator or combination unit (i.e., includes an irrigating function), the oral cleansing device 100 may include a reservoir 106. The reservoir 106 may include a lid 108 that acts to partially or fully cover a fluid compartment. The reservoir 106 may hold a fluid, such as water or mouthwash, and may be supported on the base 104.

In embodiments where the oral cleansing device 100 includes an irrigating function, the oral cleansing device 100 may include a pumping system fluidically connected to the reservoir 106 and the handle 102, that provides fluid from the reservoir 106 to the handle 102. A pumping system that may be used with the oral cleansing device 100 is described in U.S. Pat. No. 8,641,649 entitled “Pump for Dental Water Jet,” which is incorporated by reference herein in its entirety for all purposes.

In embodiments where the oral cleansing device 100 includes an irrigating function, the oral irrigator may include a hose 114 that fluidly connects the reservoir 106 to the handle 102. Optionally, a fluid connector 118 may connect the hose 114 to the handle 102. Depending on the application, the fluid connector 118 may be removably connected to the handle 102 or may be fixed to the handle 102. For example, the fluid connector 118 may be removable from the handle 102 to allow the handle 102 to be operated without a fluid source (e.g., in brush only mode) and/or allow easier storage and traveling. In some embodiments, the fluid connector 118 may be rotationally coupled to the handle 102 such that the fluid connector 118 may rotate about an axis relative to the handle 102. The fluid connector 118 may be similar to the fluid connector shown and described in U.S. Pat. No. 10,449,023 entitled “Oral Cleansing Device with Energy Conservation,” which is incorporated by reference herein in its entirety for all purposes.

The handle 102 may include one or more control buttons 120 that control (e.g., selectively activate and deactivate) one or more functions and/or modes of the oral cleansing device 100. For example, the one or more control buttons 120 may control a brushing function and/or an irrigating function of the oral cleansing device 100. For instance, the one or more control buttons 120 may selectively activate and deactivate an oscillation of the tip 112 associated with a brushing function of the oral cleansing device 100. In some embodiments, the one or more control buttons 120 may selectively control a water pressure and/or a pulse length of an irrigating function of the handle 102. The number and function control of the control buttons 120 may be varied based on a desired functionality of the oral cleansing device 100. As shown, the control buttons 120 may be connected to the handle 102 or any other convenient location for the user. For example, in some embodiments, a control button 116 may be connected to the base 104, such as a front or sidewall of the base 104.

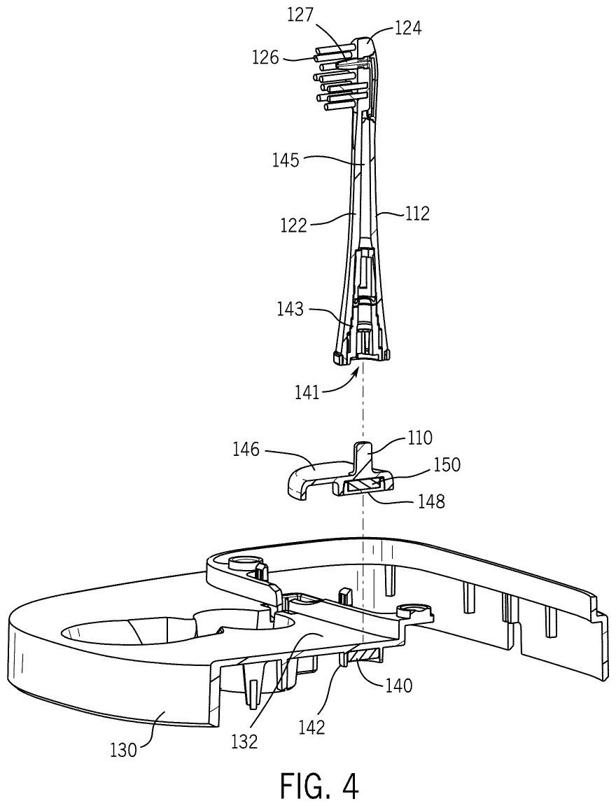

The tip 112 may include various configurations to provide a brushing function and/or an irrigating function of the oral cleansing device 100. In some instances, the tip 112 may be a brush head similar to the brush head shown in U.S. patent application Ser. No. 16/822,935 entitled “Brush Head for an Oral Cleansing Device,” filed on Mar. 18, 2020 and incorporated by reference, for all purposes, herein. For instance, the tip 112 may include a shaft 122 and one or more cleaning elements 124. Depending on the application, the one or more cleaning elements 124 may include a plurality of bristles 126 and/or a nozzle 127. As shown, the nozzle 127 may be embedded in the bristles 126, such as extending amongst the bristles 126 (e.g., within a center region or field of the bristles 126). With reference to FIG. 4, the tip 112 may also include an open bottom end 141, which may define a drive shaft opening, to couple to a drive shaft on the handle 102. The tip may also include an adapter 143 that may couple the tip 112 to the handle 102, e.g., rotationally couple the tip 112 to a drive shaft of the handle 102.

In some instances, such as when the oral cleansing device 100 is a combination brushing and irrigating unit, the tip 112 may include bristles and a fluid pathway 145 in fluid communication with the nozzle 127. In this manner, fluid may travel through the open bottom end 141 and through a drive shaft or other fluid delivery element of the handle 102 and into the fluid pathway 145.

In other examples, the tip 112 may be a jet tip and include a fluid pathway that terminates in a nozzle. Other tip 112 variations are envisioned as well, including specialty tips that clean certain features (e.g., orthodontics tips, dental implant tips, tongue cleanser tips), and the like.

The tip 112 may be removably connected to the handle 102. For instance, the shaft 122 of the tip 112 may be removably connected to a drive shaft 111 and/or fluid connector of the handle 102. In one example, the shaft 122 may include the open bottom end 141, and the opening may be configured to receive the drive shaft and/or fluid connector. The removability of the tip 112 may provide many benefits. For instance, the removability of the tip 112 may allow a user to replace the tip 112 as desired, such as when the tip 112 reaches its useful end of life, is damaged, or is contaminated, among others. In addition, the removability of the tip 112 may allow multiple users to hygienically use the same handle 102, with each user attaching a respective tip 112 to the handle 102 for separate use. Similarly, the removability of the tip 112 may allow a single user to vary the desired cleansing characteristics of the oral cleansing device 100, e.g., by changing a brush head tip for a jet nozzle tip.

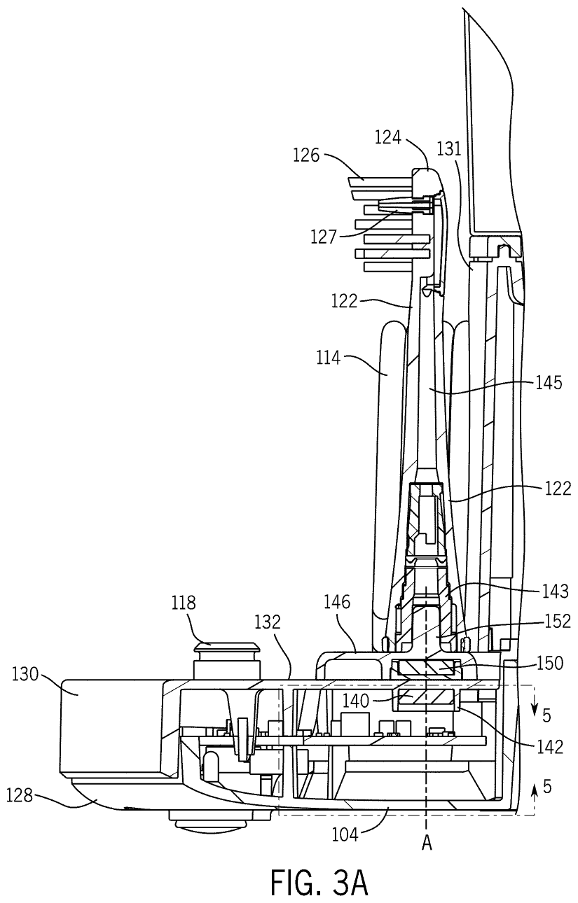

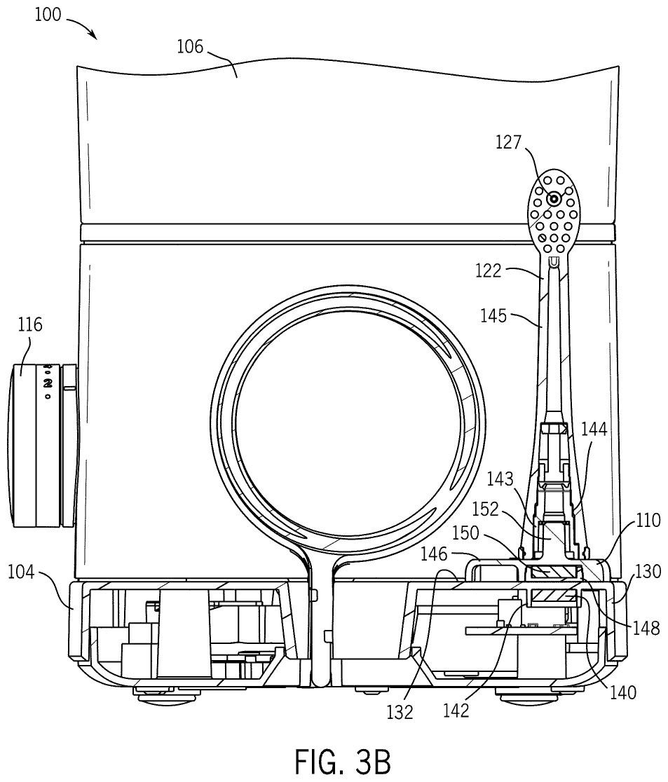

The oral cleansing device 100 may include a magnetic element 140, which may be referred to as a base magnet or ferromagnetic material, for securing a removable tip holder 110 to the base 104. FIGS. 3A-4 illustrate cross-sections of the oral cleansing device 100 taken from different views. With reference to FIGS. 3A, 3B, and 4, the oral cleansing device 100 may include a magnetic element 140 positioned or secured to an interior of the base 104. The magnetic element 140 is configured to interact with the tip holder 110 to secure the tip holder 110 to the base 104, as well assist in positioning the tip holder 110 on the base 104. The magnetic element 140 may be a magnetthat exerts a magnetic force, such as a permanent magnet and/or electromagnet. Examples of materials for the magnetic element 140 include, but are not limited to, iron, cobalt, metals, alloys, aluminum, and combinations thereof. The magnetic element 140 may also be formed in any shape and thickness as desired, depending on the desired attraction force to be exerted, the thickness and type of the base 104 material, and its position within the base 104. In one example, the magnetic element 140 may be formed as a cylindrical disk, but other geometric or amorphous shapes are envisioned as well.

The magnetic element 140 may be supported within the base 104 in various manners. As illustrated in FIGS. 3A, 3B, and 4, the magnetic element 140 may be coupled to an interior surface of the base 104 such that it is not visible to a user. In this manner, the base 104 may have a “clean” and pleasing appearance when the tip holder 110 is removed from the base 104. In some embodiments, the magnetic element 140 may be attached to the platform 130 of the base 104. For example, the magnetic element 140 may be coupled to an interior surface of the top surface 132 of the platform 130, such that the tip holder 110 may be placed on the top surface 132 of the platform 130 and magnetically retained in a desired position via magnetic element 140. With reference to FIGS. 3A, 3B, and 4, a retaining structure 142 may extend from or be attached to an interior surface of the platform 130. The retaining structure 142 may be formed as a wall extending downward from the bottom interior surface of the platform 130.

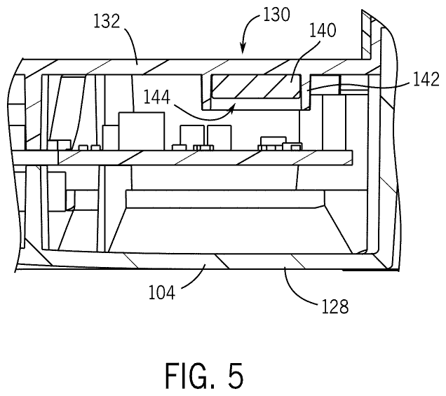

With reference to FIG. 5, which is an enlarged view of the cross-section of FIG. 3A, in one implementation, the retaining structure 142 may be formed integrally or as a unitary structure with the platform 130, e.g., via injection molding. However in other implementations, the retaining structure 142 may be coupled to the platform 130 in other manners, e.g., fasteners, adhesive, welding, or the like. The retaining structure 142 may take various forms, but in one implementation, may be defined as a circular or semicircular wall that generally matches, or corresponds to, the shape of the magnetic element 140, such that the magnetic element 140 may be received into a pocket 144 or compartment defined by the retaining structure 142. In some embodiments, the retaining structure 142 may have a height that is equal to, less than, or more than a thickness of the magnetic element 140. In one implementation, as shown in FIG. 5, the retaining structure 142 has a height larger than a thickness of the magnetic element 140, such that the retaining structure 142 extends downward from the interior surface a distance greater than a thickness of the magnetic element 140.

The base 104 may be assembled such that the magnetic element 140 may be positioned within the retaining structure 142, e.g., inserted into the pocket 144, before the base 104 is enclosed. The magnetic element 140 may be inserted into the pocket 144 of the retaining structure 142 and secured in position on the platform 130. In one example, the magnetic element 140 may be secured via adhesive, heat staking, but other manners are envisioned as well, e.g., a cap may be coupled to the retaining structure 142, welding, fasteners, or the like may be used to secure the magnetic element 140 in position. In one example, the retaining structure 142 may be formed of a plastic and a heat source may be used to soften the plastic sufficiently that the plastic deforms, collapsing partially around the magnetic element 140, and after the heat source is removed, the plastic hardens securing the magnetic element 140 in place.

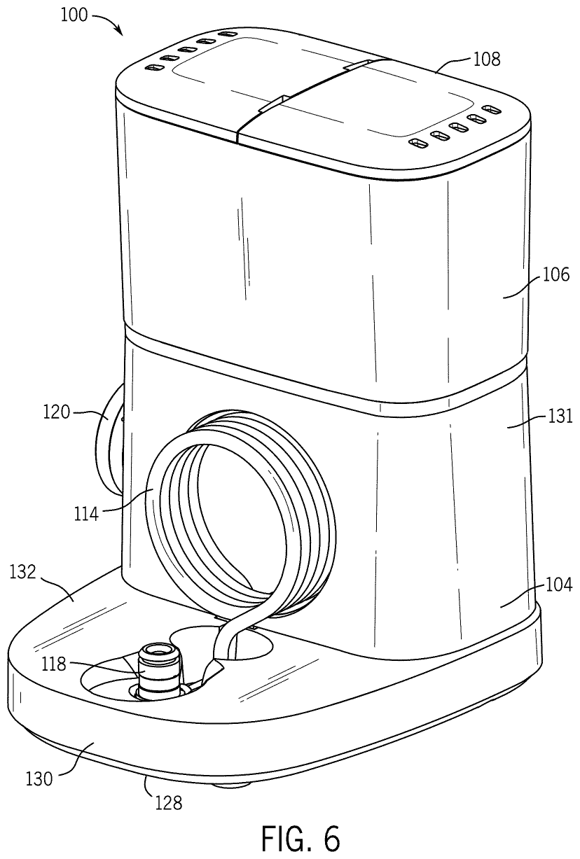

With reference to FIG. 1, the tip holder 110 may be removably coupled to the base 104 or other portion of the housing of the oral cleansing device 100. As shown in FIGS. 6 and 7, when the tip holder 110 is removed, the oral cleansing device 100, and specifically the base 104, may have an aesthetically pleasing appearance, with no indents, recesses, walls, or the like, defining where the tip holder 110 should be positioned. This allows users that do not wish to have the tip holder 110 secured to the oral cleansing device 100 to have an aesthetically pleasing unit and avoid possible dirt, fluid, and debris collection areas that can occur with non-removable tip storage options.

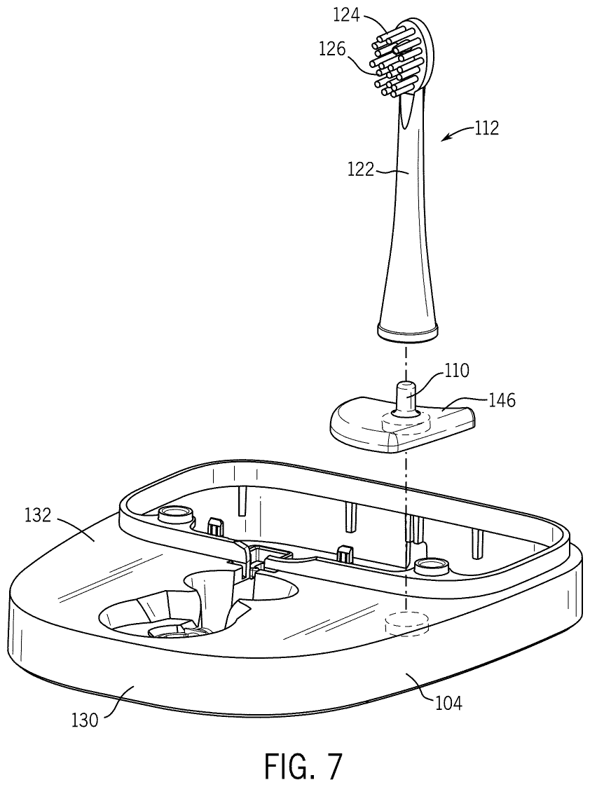

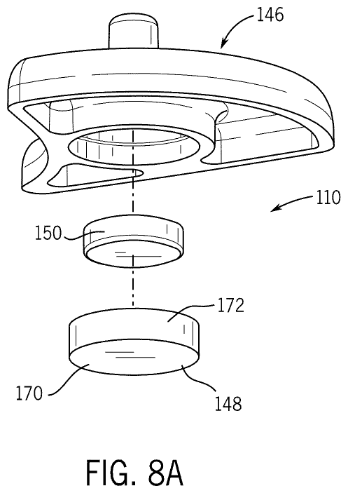

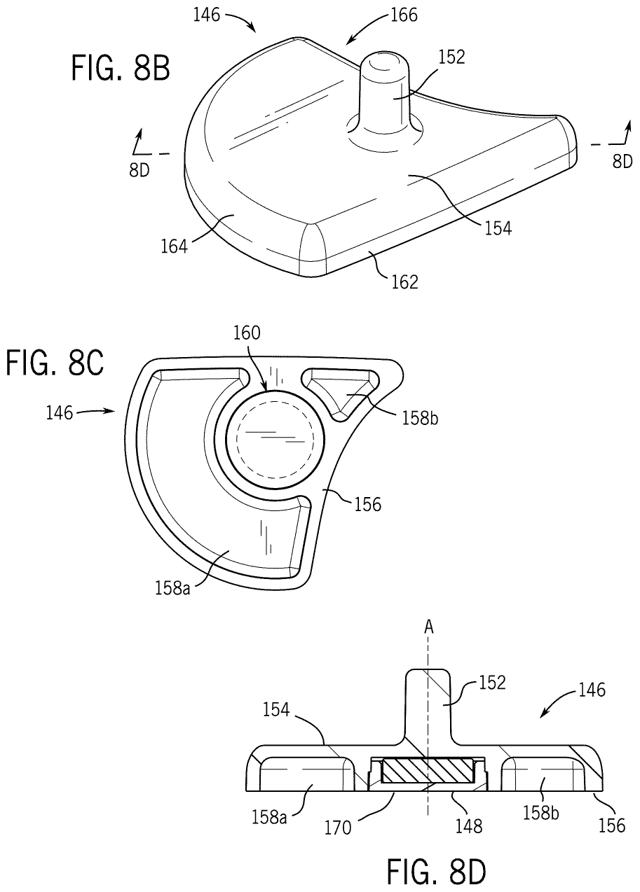

FIG. 8A is an exploded view of the tip holder 110. FIG. 8B is a top isometric view of the tip holder 110. FIG. 8C is a bottom plan view of the tip holder 110. FIG. 8D is a cross-section of the tip holder 110 taken along line 8D-8D. With reference to FIG. 8A, the tip holder 110 may include a magnetic element 150, which may be referred to as a holder magnet or ferromagnetic material. The magnetic element 140 and the magnetic element 150 are configured to magnetically attract each other, such as both being magnets or one being formed as a magnet and the other being formed as a ferromagnetic material. The magnetic element 150 may be formed of the same or similar materials and have a similar shape as the magnetic element 140. For example, the magnetic element 150 may be formed as a cylindrical disk and be formed of magnetic material. The magnetic element 150 may be configured, either through orientation and/or polarization, to exert a magnetic force attractive to the magnetic element 140.

With reference to FIG. 8A-8D, the tip holder 110 may include a base or support stand 146. The support stand 146 supports the tip 112 when the tip is positioned on the tip holder 110. The support stand 146 may be shaped in aesthetically pleasing ways, as well as have a footprint sufficient to support the tip 112 thereon and sit within the desired areas of the base 104. In one example, the support stand 146 has varying curvature in its sidewalls, including a first sidewall 162 extending lengthwise in a relatively straight manner, a second sidewall 164 having a convexly shaped lengthwise extension, and a third sidewall 166 having a slight concave shaped lengthwise extension, where the three sidewalls may generally from a triangular shaped member, albeit one with one or more curved edges.

A top surface 154 of the support stand 146 may define a user-facing surface for the tip holder 110. A post 152 or tip retainer may extend from the top surface 154 and may be configured to support the tip 112. In these implementations, the post 152 may support the tip 112 in an upright position, and the support stand 146 may ensure the tip holder 110 and the tip 112 are stable in the upright position. In some implementations, one or more grooves, walls, or other structural supports may be included instead of or in addition to the post 152 in order to support the tip 112 on the tip holder 110. For example, in instances where the tip 112 may be a jet tip, the tip support structure may be formed of a cylindrical recess that receives the bottom end of the tip 112.

The bottom surface of the tip holder 110 may rest against the top surface 132 of the platform 130. With reference to FIG. 8C, a bottom surface 156 of the support stand 146 may be configured to interface with the top surface 132 of the base 104. In some embodiments, the bottom surface 156 may include one or more recesses 158a, 158b, which may be formed to reduce the weight of the tip holder 110, for structural support (e.g., defining trusses or ribs within the support stand 146), for manufacturing purposes (e.g., injection molding techniques), or the like.

The support stand 146 may include a reception cavity 160 or pocket defined on the bottom surface 156. The reception cavity 160 may be configured to receive the magnetic element 150 therein and may define a compartment for the magnet 150 to seat within. With reference to FIG. 8D, in one embodiment, a center axis A of the reception cavity 160 may be aligned with a center axis A of the post 152. This alignment may help to ensure that tip holder 110 remains balanced relative to the connection to the base 104 with or without a tip 112 positioned on the tip holder 110.

With reference to FIGS. 8A and 8D, the tip holder 110 may optionally include a cap 148. The cap 148 may help to retain the magnet 150 within the reception cavity 160, as well as enclose the reception cavity 160. For example, the cap 148 may include a bottom end 170 and a wall 172 extending upwards from the bottom end 170 to define a compartment between the interior of the wall 172, e.g., the cap 148 may be formed as a hollow cylindrical enclosed at one end. The height or thickness of the cap 148 may be selected to substantially match or be slightly less than a depth of the reception cavity 160, such that when the cap 148 is positioned therein, the cap 148 may be flush with the bottom surface 156.

With reference to FIGS. 8A and 8D, the tip holder 110 may be coupled together, such that the magnet 150 is positioned within the reception cavity 160 of the support stand 146. The cap 148 may be inserted into the reception cavity 160 with the wall 172 surrounding the perimeter of the magnetic element 150 and having a tight fit to help prevent ingress of fluid and debris into the reception cavity 160. The cap 148 may optionally be secured to the support stand 146, e.g., via welding, adhesive, fasteners, or the like. In some embodiments, once the cap 148 is secured to the support stand 146, the bottom end 170 of the cap 148 or other exterior portion may be flush with the bottom surface 156, allowing the tip holder 110 to sit evenly on a surface, such as when placed on the top surface 132 of the platform 130. In other embodiments, the cap 148 may be omitted and the magnetic element 150 may be secured in other manners to the support stand 146, e.g., adhesive, heat staking, fasteners or the like. In these embodiments, the magnetic element 150 may optionally have an extended thickness or otherwise be positioned within the reception cavity 160 such that a bottom surface of the magnetic element 150 is flush with the bottom surface 156 of the support stand 146.

With reference to FIG. 1, in use, the user may position the tip holder 110 on the base 104, such as on the top surface 132 of the platform 130. As the user places the tip holder 110 onto the base 104, the magnetic elements 140, 150 of the base 104 and the tip holder 110, respectively, exert a pulling or attraction force towards one another. This may create a “home in” force allowing the user to position the tip holder 110 in the desired area that aligns with the location of the base magnetic element 140. For example, as shown in FIG. 3A, the tip holder 110 may be aligned on the base 104 such that the two magnetic elements 140, 150 are aligned with one another, and the center axis A of the post 152 is aligned with a center axis of the base magnetic element 140.

With reference to FIGS. 3A and 3B, the bottom surface 156 of the support stand 146 and the bottom end 170 of the cap 148 may abut against the top surface 132 of the platform 130. The sidewalls of the support stand 146 may extend to the top surface 132 to create an integral appearance, although the sidewalls are not formed with the base 104.

With continued reference to FIGS. 3A and 3B, once the tip holder 110 is positioned on the base 104, the user may optionally insert and/or remove the tip 112 from the tip holder 110. For example, when positioned on the tip holder 110, the open end of the tip 112, such as the end that receives the drive shaft 111, may be positioned over the support stand 146 and the post 152 may be received into the open end of the tip 112. In this manner, the post 152 may be configured to have a diameter that substantially matches a diameter of the drive shaft 111 or other mechanical element that the tip 112 is configured to couple to on the handle 102. As shown in FIG. 1, in this configuration, the user may easily reach the tip 112 to change out the tip 112 as desired. Additionally, in some embodiments, the post 152 of the tip holder 110 may be configured to support the tip 112 in an upright manner, which may be perpendicular to the bottom surface of the support stand 146 and/or perpendicular to the top surface 132 of the platform 130.

With reference to FIG. 6, in instances where the user may not wish to include the tip holder 110 on the device, e.g., the user may not share the oral cleansing device 100 with others or prefers a single tip, the user may remove the tip holder 110 from the base 104. For example, the user may grasp the support stand 146 and exert an upward force sufficient to overcome the magnetic force exerted between the two magnetic elements 140, 150. As the force exceeds the magnetic attraction, the user will be able to lift the tip holder 110 up from the base 104 and store the tip holder 110 or dispose of the tip holder 110 as desired. With reference to FIG. 6, in such configurations, the base 104 and specifically the top surface 132 of the platform 130 may appear as the tip holder 110 was never positioned there, e.g., the base 104 may not include or may be free from markings, icons, indentations, or the like. In other embodiments, however, the base 104 may include certain marks, indentations, or the like, that help the user to determine where the tip holder 110 should be positioned.

All relative and directional references (including top, bottom, side, front, rear, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

The present disclosure teaches by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. An oral cleansing device comprising:
a base; and
a tip holder configured to hold a tip for the oral cleansing device, wherein the tip holder is removably coupled to a top surface of the base.

2. The oral cleansing device of claim 1, wherein the tip holder comprises:
a support stand; and
a magnetic element coupled to the support stand, wherein the magnetic element secures the tip holder onto the top surface of the base.

3. The oral cleansing device of claim 2, wherein the base further comprises a base magnetic element positioned within an interior of the base, wherein the base magnetic element exerts an attraction force on the magnetic element of the tip holder to secure the tip holder to the top surface of the base.

4. The oral cleansing device of claim 2, wherein the support stand comprises a post for supporting a tip thereon.

5. The oral cleansing device of claim 1, wherein the top surface of the base is free from indentations or icons indicating a location of where the tip holder is securable to the base.

6. The oral cleansing device of claim 1, wherein the tip is at least one of a brush head, an irrigating jet tip, or a combination brush head and nozzle.

7. A tip holder for use with an oral cleansing device comprising:
a support stand;
a tip retainer extending from the support stand; and
a magnetic element coupled to the support stand and configured to removably secure the tip holder to the oral cleansing device.

8. The tip holder of claim 7, wherein the support stand further comprises a pocket defined on a bottom surface thereof, wherein the magnetic element is received within the pocket.

9. The tip holder of claim 8, further comprising a cap positioned at least partially within the pocket and secured to the support stand, wherein the cap acts to retain the magnetic element within the pocket.

10. The tip holder of claim 9, wherein an exterior surface of the cap is flush with the bottom surface of the support stand.

11. The tip holder of claim 7, wherein the tip retainer comprises a post configured to support a tip for the oral cleansing device.

12. An oral cleansing device comprising:
a reservoir;
a handle having a removable tip and in fluid communication with the reservoir;
a base supporting the reservoir; and
a tip holder removably coupled to the base and configured to support the removable tip in an upright position relative to the base.

13. The oral cleansing device of claim 12, wherein the tip holder is removably coupled to a top surface of the base adjacent to the reservoir.

14. The oral cleansing device of claim 12, wherein:
the base includes a first magnetic element positioned below a top surface of the base; and
the tip holder includes a second magnetic element, wherein an interaction between the first magnetic element and the second magnetic element acts to removably couple the tip holder to the base.

15. The oral cleansing device of claim 14, wherein the base comprises a retaining structure coupled to an interior surface, wherein the first magnetic element is received within the retaining structure.

16. The oral cleansing device of claim 14, wherein the first magnetic element is not visible from an exterior of the base.

17. The oral cleansing device of claim 12, wherein the tip holder comprises:
a support stand; and
a post coupled to the support stand and configured to support the removable tip.

18. The oral cleansing device of claim 17, wherein the tip holder further comprises a magnet, and the magnet is received within a pocket of the support stand.

19. The oral cleansing device of claim 18, wherein the tip holder further comprises a cap to secure the magnet within the pocket, wherein a portion of the cap is flush with a bottom surface of the support stand.

20. The oral cleansing device of claim 12, wherein the removable tip is a brush head or a jet tip.
